(19) United States
(12) Patent Application Publication
(10) Pub. No.: US 2013/0213031 A1
(43) Pub. Date: Aug. 22, 2013

(54) HYDRAULIC SYSTEM FOR A CONSTRUCTION MACHINE

(71) Applicants: Jae-Whan Ok, Busan (KR); Jin-Youn Choi, Changwon-si (KR)

(72) Inventors: Jae-Whan Ok, Busan (KR); Jin-Youn Choi, Changwon-si (KR)

(73) Assignee: VOLVO CONSTRUCTION EQUIPMENT AB, Eskilstuna (SE)

(21) Appl. No.: 13/879,757

(22) PCT Filed: Oct. 20, 2010
(86) PCT No.: PCT/KR2010/007175

§ 371 Date: Apr. 16, 2013

(51) Int. Cl. F15B 15/00

(52) U.S. Cl. CPC F15B 15/00
USPC 60/486

(57) ABSTRACT

Disclosed is a hydraulic system for a construction machine, which makes it possible to adjust the geometric position of a working device comprising a boom and an arm by means of a single manipulation lever, thereby enabling a leveling/flattening process to be conveniently performed. The hydraulic system includes: a working mode selection switch for selecting a leveling/flattening process; a boom driving switch valve for controlling the driving of a boom cylinder in response to a control signal from a first manipulation lever; an arm driving switch valve for controlling the driving of an arm cylinder in response to a control signal from a second manipulation lever; a shuttle valve including input parts that connect to both an electronic proportional control valve and to the first manipulation lever, respectively, and an output part connecting to the boom driving switch valve; and an electronic controller.

### FIELD OF THE INVENTION

The present invention relates to a hydraulic system for construction equipment, which is configured to perform a leveling work using an excavator. More particularly, the present invention relates to such a hydraulic system which is configured to conveniently perform a leveling work by simultaneously manipulating work apparatuses such as a boom and an arm using a single manipulation lever (RCV).

### BACKGROUND OF THE INVENTION

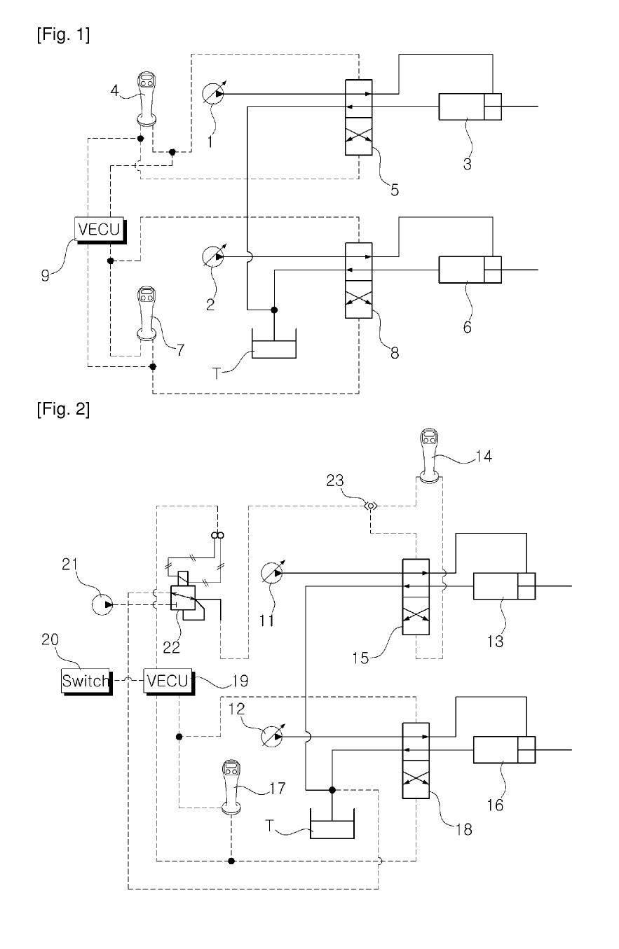

A conventional hydraulic system for construction equipment as shown in FIG. 1 includes:
first and second variable displacement hydraulic pumps (hereinafter, referred to as “first and second hydraulic pumps”) 1 and 2;
a boom cylinder 3 connected to the first hydraulic pump 1;
first and second manipulation levers 4 and 7 (for example, hydraulic joysticks are used) configured to generate control signals in proportion to an operator's manipulation amounts, respectively;
a boom-driving switching valve 5 installed in a flow path between the first hydraulic pump 1 and the boom cylinder 3 and configured to control a start, a stop, and a direction change of the boom cylinder 3 when a spool is shifted in response to the control signal generated from the first manipulation lever 4;
an arm cylinder 6 connected to the second hydraulic pump 2;
an arm-driving switching valve 8 installed in a flow path between the second hydraulic pump 2 and the arm cylinder 6 and configured to control a start, a stop, and a direction change of the arm cylinder 6 when a spool is shifted in response to the control signal generated from the second manipulation lever 7; and
an electronic controller (V-ECU) 9 configured to detect the control signals (referring to secondary signal pressures) that are generated in accordance with the manipulation of the first and second manipulation levers 4 and 7, and control the discharge flow rates of the first and second hydraulic pump 1 and 2 based on the detected control signals, respectively.

Thus, when an operator manipulates the first and second manipulation levers 4 and 7 simultaneously to shift the spools of the boom-driving switching valve 5 and the arm-driving switching valve 8, the boom cylinder 3 and the arm cylinder 6 are driven by hydraulic fluids supplied thereto from the first and second hydraulic pumps 1 and 2, respectively, to perform a leveling work.

The conventional hydraulic system for construction equipment entails a problem in that since the operator must manipulate the first and second manipulation levers 4 and 7 properly in a geometrical manner to distribute the hydraulic fluids supplied to the boom cylinder 3 and the arm cylinder 6, which makes it difficult to control the geometrical position of the work apparatuses such as the boom and the arm, leading to an increase in the time spent to perform a leveling work through the simultaneous manipulation of the first and second manipulation levers 4 and 7, and thus causing a deterioration of the work efficiency.

### DETAILED DESCRIPTION OF THE INVENTION

### Technical Problems

Accordingly, the present invention was made to solve the aforementioned problem occurring in the prior art, and it is an object of the present invention to provide a hydraulic system for construction equipment, in which the geometrical position of work apparatuses (referring to a boom and an arm) is controlled by manipulation of a single manipulation lever to conveniently perform a leveling work, thereby shortening the work time and thus improving the work efficiency of construction equipment.

### Technical Solution

To accomplish the above object, in accordance with an embodiment of the present invention, there is provided a hydraulic system for construction equipment.

The hydraulic system for construction equipment includes:
first and second variable displacement hydraulic pumps;
first and second manipulation levers configured to generate control signals in proportion to an operator's manipulation amounts, respectively;
a working mode selection switch configured to select a leveling work;
a boom cylinder connected to the first hydraulic pump;
a boom-driving switching valve installed in a flow path between the first hydraulic pump and the boom cylinder and shifted in response to the control signal generated from the first manipulation lever to control a start, a stop, and a direction change of the boom cylinder;
an arm cylinder connected to the second hydraulic pump;
an arm-driving switching valve installed in a flow path between the second hydraulic pump and the arm cylinder and shifted in response to the control signal generated from the second manipulation lever to control a start, a stop, and a direction change of the arm cylinder;
an electrical proportional pressure control valve configured to generate a secondary control signal indicative of a signal pressure in proportional to an electric control signal applied thereto from the outside;
a shuttle valve connected at input portions thereof to the electrical proportional pressure control valve and the first manipulation lever, respectively, and connected at an output portion thereof to the boom-driving switching valve; and
an electronic controller configured to detect and calculate a control signal that is generated from the second manipulation lever in accordance with the manipulation of the second manipulation lever, control the discharge flow rate of the second hydraulic pump based on the calculated control signal value, and control the discharge flow rate of the first hydraulic pump by shifting the boom-driving switching valve through the shuttle valve using the secondary control signal that is generated from the electrical proportional pressure control valve in proportional to the calculated control signal value, in the case where a control signal in accordance with selection of the leveling work is applied to the electronic controller from the working mode selection switch.

In the hydraulic system for construction equipment, the arm-driving switching valve and the boom-driving switching valve may be shifted by an electric joystick connected to the electronic controller.

In the hydraulic system for construction equipment, the arm-driving switching valve and the boom-driving switching valve may be shifted by the electrical proportional pressure control valve that generates the secondary control signal in proportion to the electric control signal outputted from the electric joystick connected to the electronic controller.

### Advantageous Effect

The hydraulic system according to the embodiment of the present invention as constructed above has the following advantage.

The geometrical position of work apparatuses such as a boom and an arm is controlled by manipulation of one manipulation lever to conveniently perform a leveling work using an excavator, thereby shortening the work time and thus improving the work efficiency of construction equipment.

### BRIEF DESCRIPTION OF THE INVENTION

The above objects, other features and advantages of the present invention will become more apparent by describing the preferred embodiments thereof with reference to the accompanying drawings, in which:

FIG. 1 is a schematic block diagram showing a hydraulic system for construction equipment in accordance with the prior art; and

FIG. 2 is a schematic block diagram showing a hydraulic system for construction equipment in accordance with an embodiment of the present invention;

### EXPLANATION ON REFERENCE NUMERALS OF MAIN ELEMENTS IN THE DRAWINGS

11: first variable displacement hydraulic pump
12: second variable displacement hydraulic pump
13: boom cylinder
14: first manipulation lever
15: boom-driving switching valve
16: arm cylinder
17: second manipulation lever
18: arm-driving switching valve
19: electronic controller (V-ECU)
20: working mode selection switch
21: hydraulic pump
22: electrical proportional pressure control valve
23: shuttle valve

### PREFERRED EMBODIMENTS OF THE INVENTION

Now, preferred embodiments of the present invention will be described in detail with reference to the accompanying drawings. The matters defined in the description, such as the detailed construction and elements, are nothing but specific details provided to assist those of ordinary skill in the art in a comprehensive understanding of the invention, and the present invention is not limited to the embodiments disclosed hereinafter.

As shown in FIG. 2, the hydraulic system for construction equipment according to an embodiment of the present invention includes:
first and second variable displacement hydraulic pumps (hereinafter, referred to as “first and second hydraulic pumps”) 11 and 12;
first and second manipulation levers (for example, hydraulic joysticks are used) 14 and 17 configured to generate control signals in proportion to an operator's manipulation amounts, respectively;
a working mode selection switch 20 configured to select a leveling work;
a boom cylinder 13 connected to the first hydraulic pump 11;
a boom-driving switching valve 15 installed in a flow path between the first hydraulic pump 11 and the boom cylinder 13 and shifted in response to the control signal generated from the first manipulation lever 14 to control a start, a stop, and a direction change of the boom cylinder 13;
an arm cylinder 16 connected to the second hydraulic pump 12;
an arm-driving switching valve 18 installed in a flow path between the second hydraulic pump 12 and the arm cylinder 16 and shifted in response to the control signal generated from the second manipulation lever 17 to control a start, a stop, and a direction change of the arm cylinder 16;
an electrical proportional pressure control valve 22 configured to generate a secondary control signal (referring to signal pressure) in proportional to an electric control signal applied thereto from the outside;
a shuttle valve 23 connected at input portions thereof to the electrical proportional pressure control valve 22 and the first manipulation lever 14, respectively, and connected at an output portion thereof to the boom-driving switching valve 15; and
an electronic controller (V-ECU) 19 configured to detect and calculate a control signal that is generated from the second manipulation lever in accordance with the manipulation of the second manipulation lever 17, control the discharge flow rate of the second hydraulic pump 12 based on the calculated control signal value, and control the discharge flow rate of the first hydraulic pump 1 by shifting the boom-driving switching valve through the shuttle valve using the secondary control signal that is generated from the electrical proportional pressure control valve 22 in proportional to the calculated control signal value, in the case where a control signal in accordance with selection of the leveling work is applied to the electronic controller from the working mode selection switch 20.

In drawings, a non-explained reference numeral 21 denotes a fixed displacement hydraulic pump that discharges a pilot signal pressure, which is in turn supplied to the boom-driving switching valve 15 and the arm-driving switching valve 18, to shift the boom-driving switching valve 15 and the arm-driving switching valve 18 when the first and second manipulation levers 14 and 17 are manipulated.

The use example of the hydraulic system for construction equipment according to an embodiment of the present invention will be described hereinafter in detail with reference to the accompanying drawings.

As shown in FIG. 2, a spool of the boom-driving switching valve 15 is shifted in response to a control signal that is generated from the first manipulation lever in accordance with the manipulation of the first manipulation lever 14, so that the boom cylinder 13 can be driven by a hydraulic fluid supplied thereto from the first hydraulic pump 11. In this case, the hydraulic fluid returning from the boom cylinder 13 is moved to a hydraulic tank T via the boom-driving switching valve 15.

In addition, a spool of the arm-driving switching valve 18 is shifted in response to a control signal that is generated from the second manipulation lever in accordance with the manipulation of the first manipulation lever 17, so that the arm cylinder 16 can be driven by a hydraulic fluid supplied thereto from the second hydraulic pump 12. In this case, the hydraulic fluid returning from the arm cylinder 16 is moved to the hydraulic tank T via the arm-driving switching valve 18.

In the meantime, the spools of the arm-driving switching valve 18 and the boom-driving switching valve 15 are shifted simultaneously by manipulation of the second manipulation lever 17, so that the discharge flow rates of the first and second hydraulic pumps 11 and 12 can be controlled to conveniently perform the leveling work using the work apparatuses such as the boom and arm.

That is, when an operator manipulates the working mode selection switch 20, a control signal from the working mode selection switch 20 is applied to the electronic controller 19 to perform the leveling work using an excavator. At this time, the electronic controller 19 recognizes that the work mode is converted to a leveling work mode.

The spool of the arm-driving switching valve 18 is shifted in response to the control signal generated from the second manipulation lever 17 in accordance with the manipulation of the second manipulation lever 17 to cause the hydraulic fluid from the second hydraulic pump 12 to be supplied to the arm cylinder 16. In this case, the electronic controller 19 detects and calculates the control signal from generated from the second manipulation lever 17 in accordance with the manipulation of the second manipulation lever 17. The electronic controller 19 controls the discharge flow rate of the hydraulic fluid, which is to be supplied to the arm cylinder 16 from the second hydraulic pump 12 based on the calculated control signal value. At the same time, the electrical proportional pressure control valve 22 generates a secondary control signal in proportional to an electric control signal applied thereto from the electronic controller 19 based on the calculated control signal

Meanwhile, the electronic controller 19 controls the discharge flow rate of the hydraulic fluid, which is to be supplied to the boom cylinder 13 from the first hydraulic pump 11 by controlling the shift of a spool of the boom-driving switching valve 15 through the shuttle valve 23 using the secondary control signal generated from the electrical proportional pressure control valve 22.

Thus, the spool of the arm-driving switching valve 18 is shifted in response to the control signal generated from the second manipulation lever 17 in accordance with the manipulation of the second manipulation lever 17 so that the flow rate of the hydraulic fluid supplied to the arm cylinder 16 from the second hydraulic pump 12 can be controlled. At this time, the electronic controller 19 detects and calculates the control signal from generated from the second manipulation lever 17 in accordance with the manipulation of the second manipulation lever 17, and generates an electric control signal in response to the calculated control signal value for application to the electrical proportional pressure control valve 22.

The spool of the boom-driving switching valve 15 is shifted in response to a secondary control signal generated from the electrical proportional pressure control valve 22 in proportional to the electric control signal applied to the electrical proportional pressure control valve 22 so that the flow rate of the hydraulic fluid supplied to the boom cylinder 13 from the first hydraulic pump 11 can be controlled.

As such, the spools of the arm-driving switching valve 18 and the boom-driving switching valve 15 are shifted simultaneously by manipulation of a single second manipulation lever 17, so that the arm cylinder 16 and the boom cylinder 13 can be driven to conveniently perform the leveling work.

Meanwhile, although not shown in the drawing, the arm cylinder may be connected to the first hydraulic pump 11 and the boom cylinder is connected to the second hydraulic pump 12 to cause a boom-driving switching valve (i.e., control valve denoted by reference numeral 18) to be shifted by manipulation of the second manipulation lever 17 so that the flow rate of the hydraulic fluid supplied to the boom cylinder from the second hydraulic pump 12 can be controlled. At the same time, the electronic controller 19 detects and calculates a control signal from generated from the second manipulation lever 17 in accordance with the manipulation of the second manipulation lever 17, and the electrical proportional pressure control valve 22 generates a secondary control signal in proportional to an electric control signal applied thereto from the electronic controller 19 in response to the calculated control signal outputted from the electronic controller 19. An arm-driving switching valve (i.e., control valve denoted by reference numeral 15) to be shifted in response to the secondary control signal generated from the electrical proportional pressure control valve 22 through the operation of the shuttle valve 23 so that the flow rate of the hydraulic fluid supplied to the arm cylinder from the first hydraulic pump 11 can be controlled.

Although not shown in the drawing, it is of course to be noted that the arm-driving switching valve 18 and the boom-driving switching valve 15 may be shifted by electric joysticks connected to the electronic controller 19.

Also, although not shown in the drawing, it is of course to be noted that the arm-driving switching valve 18 and the boom-driving switching valve 15 may be shifted by the electrical proportional pressure control valve 22 that generates the secondary control signal in proportion to the electric control signal outputted from the electric joysticks connected to the electronic controller 19.

### INDUSTRIAL APPLICABILITY

According to the hydraulic system for construction equipment of the present invention as constructed above, in the case where the leveling work is performed using an excavator, the arm-driving switching valve is shifted by manipulation of an arm manipulation lever to drive an work apparatus such as an arm, and simultaneously the boom-driving switching valve is shifted, so that a leveling work is conveniently performed, thereby shortening the work time and thus improving the work efficiency of construction equipment.

1. A hydraulic system for construction equipment comprising:
first and second variable displacement hydraulic pumps;
first and second manipulation levers configured to generate control signals in proportion to an operator's manipulation amounts, respectively;
a working mode selection switch configured to select a leveling work;
a boom cylinder connected to the first hydraulic pump;
a boom-driving switching valve installed in a flow path between the first hydraulic pump and the boom cylinder and shifted in response to the control signal generated from the first manipulation lever to control a start, a stop, and a direction change of the boom cylinder;
an arm cylinder connected to the second hydraulic pump;
an arm-driving switching valve installed in a flow path between the second hydraulic pump and the arm cylinder and shifted in response to the control signal generated from the second manipulation lever to control a start, a stop, and a direction change of the arm cylinder;
an electrical proportional pressure control valve configured to generate a secondary control signal indicative of a signal pressure in proportional to an electric control signal applied thereto from the outside;
a shuttle valve connected at input portions thereof to the electrical proportional pressure control valve and the first manipulation lever, respectively, and connected at an output portion thereof to the boom-driving switching valve; and
an electronic controller configured to detect and calculate a control signal that is generated from the second manipulation lever in accordance with the manipulation of the second manipulation lever, control the discharge flow rate of the second hydraulic pump based on the calculated control signal value, and control the discharge flow rate of the first hydraulic pump by shifting the boom-driving switching valve through the shuttle valve using the secondary control signal that is generated from the electrical proportional pressure control valve in proportional to the calculated control signal value, in the case where a control signal in accordance with selection of the leveling work is applied to the electronic controller from the working mode selection switch.

2. The hydraulic system for construction equipment according to claim 1, wherein the arm-driving switching valve and the boom-driving switching valve are shifted by an electric joystick connected to the electronic controller.

3. The hydraulic system for construction equipment according to claim 1, wherein the arm-driving switching valve and the boom-driving switching valve are shifted by the electrical proportional pressure control valve that generates the secondary control signal in proportion to the electric control signal outputted from the electric joystick connected to the electronic controller.
